(19) United States
(12) Patent Application Publication
(10) Pub. No.: US 2026/0341872 A1
(43) Pub. Date: Oct. 29, 2026

(54) MOBILE POWER UNIT SAFETY STRUCTURE AND CONSTRUCTION

(71) Applicant: MOXION POWER CO., Richmond, CA (US)

(72) Inventors: Edward P. YANKOSKI, West Branch, MI (US); Alexander J. SMITH, Lakeside, CA (US); Steven E. YANKOSKI, West Branch, MI (US); Michael J. FUNK, Brisbane, CA (US)

(73) Assignee: MOXION POWER CO., Richmond, CA (US)

(21) Appl. No.: 19/484,243

(22) PCT Filed: May 13, 2024
(86) PCT No.: PCT/US2024/029158

§ 371 Date: Nov. 13, 2025

Related U.S. Application Data
(60) Provisional application No. 63/501,588, filed on May 11, 2023.

(51) Int. Cl. H01M 50/242; B62D 21/15; B62D 63/08; H01M 50/249; H01M 50/256; H01M 50/262

(52) U.S. Cl. CPC H01M 50/242; B62D 21/157; B62D 63/08; H01M 50/249; H01M 50/256; H01M 50/262; H01M 2220/20

(57) ABSTRACT

A battery mounting apparatus and system is disclosed. The apparatus and system include a sleeve with integrated attachment features that is attached to a battery cell. The attachment features include one or more locator pockets that enable the battery cell to attach to a receiving frame. The locator pockets include features that can self-center the sleeve with respect to the receiving frame.

### PRIORITY CLAIM

This patent application claims priority to U.S. provisional patent application no. 63/501,588, titled “BATTERY RETENTION SYSTEM WITH INTEGRAL STRUCTURAL MEMBERS,” and filed on May 11, 2023, which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The present application relates generally to all-electric, portable industrial power generators which provide temporary on-site power to industries such as construction, film, natural disasters, entertainment, power and utility, electric vehicles, and telecom. More specifically, this disclosure provides a trailer system for transporting a portable energy source.

### BACKGROUND

Energy storage systems such as rechargeable battery systems may be susceptible to damage from an impact. As developments in these electrical systems increases including ability for them to power larger applications and equipment at a jobsite, associated transportation of the energy system from one site to another currently limited by inadequate trailers failing to provide sufficient safety and maneuverability.

Typical diesel generators are designed for stationary applications. Diesel generators that are adopted to be used in conjunction with a trailer are often done so as an afterthought. Due to the potentially volatile nature that batteries can undergo during a vehicle collision, transportation of such batteries would benefit from a trailer and housing system with the capacity to accommodate forces from an impact without damaging the batteries being transported.

### SUMMARY OF THE DISCLOSURE

Described herein are apparatuses, systems, and methods to transport, store, lift attach or affix energy storage units, such as battery cells.

In general, a towable system for transporting a battery can comprise a frame having a coupling mechanism configured to attach to a vehicle and a housing operably coupled with the frame, the housing can comprise one or more compression zones configured to accommodate an impact, the housing configured to house one or more battery modules.

In this and other examples, the system may further comprise one or more of the following: one or more attachment rings coupled to an elongate member extending through the housing to the frame, a first compression zone along a length of an upper perimeter of the housing. The frame may comprise a compression member extending between a fender and a proximal side of the frame. The system may further comprise at least four attachment rings positioned on an upper surface of the housing, each attachment ring coupled to an elongate member extending through the housing to the frame. Each attachment ring can be configured to engage with a cable to lift the towable system. The housing can comprise cross members extending between elongate members of a hoist system within the housing. The housing can comprise a subframe configured to distribute force from an impact away from the one or more battery modules. The system may further comprise a top of the housing, wherein the top is a compression zone. The housing can further comprise a rear surface compression zone. The one or more compression zones can be defined by a channel extending along a length of the housing perimeter, and one or more compression supports extending across the channel.

In general, a trailer for a battery mounting system can comprise a housing with one or more compression zones, wherein the housing can be attached to a frame configured to be towed by a vehicle, the housing can be further configured receive one or more battery housings in a receiving frame, the receiving frame can comprise a locating rail attached to the receiving frame and configured to form at least one side of the receiving frame; and a first mounting bracket removably attached to the receiving frame; and a battery housing comprising: a sleeve configured to securely attach to a battery cell and at least partially cover at least three sides of the battery cell; a first locator pocket disposed on a first side of the sleeve, wherein the first locator pocket is configured to receive a first portion of the locating rail; and a second locator pocket disposed on an upper edge of a second side of the sleeve, the second side disposed opposite to and across from the first side, wherein the second locator pocket is configured to receive a first spring force from the first mounting bracket to affix and secure the battery housing against the locating rail.

This and other examples described herein can further comprise one or more of the following: one or more attachment rings coupled to an elongate member extending through the housing to the frame, a first compression zone along a length of an upper perimeter of the housing, at least four attachment rings positioned on an upper surface of the housing, each attachment ring coupled to an elongate member extending through the housing to the frame. Each attachment ring can be configured to engage with a cable to lift the towable system.

In general, a portable power system can comprise a frame configured to be towed by a vehicle, a housing attached to the frame, the housing configured to secure a power source therein, one or more compression zones configured to accommodate an impact and one or more attachment rings, each attachment ring coupled to an elongate member extending through the housing to the frame.

This and other examples described herein can further comprise one or more of the following: a first compression zone along a length of an upper perimeter of the housing. The frame can comprise a compression member extending between a fender and a proximal side of the frame. The system may further comprise at least four attachment rings positioned on an upper surface of the housing, each attachment ring coupled to an elongate member extending through the housing to the frame. Each attachment ring can be configured to engage with a cable to lift the towable system. The housing can comprise cross members extending between elongate members of a hoist system within the housing. The housing can comprise a subframe configured to distribute force from an impact away from the one or more battery modules. The system may further comprise a top positioning on the top of the housing, wherein the top is a compression zone. The housing can comprise a rear surface compression zone. The one or more compression zones may be defined by a channel extending along a length of the housing perimeter, and one or more compression supports extending across the channel.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a view of an example mobile power unit.

FIG. 2 is a view of an example mobile power unit.

FIG. 3 is a view of an example mobile power unit.

FIG. 4A to 4C shows a cross section of a rear surface of a mobile power unit with detailed views of attachment elements and hoist system.

FIG. 5 is a view of an example mobile power unit in use.

FIG. 6 shows another example view of a mobile power unit in use.

FIG. 7 shows another example view of a mobile power unit in use.

FIGS. 8A-8C show scenarios in which a vehicle collides with a mobile power unit.

FIGS. 9A-9E show additional scenarios in which a vehicle collides with a mobile power unit.

FIG. 10 is a schematic diagram showing additional safeguards against collisions in a mobile power unit.

### DETAILED DESCRIPTION

The present disclosure related to over the transportation system including a trailer mounted energy source (e.g., battery pack) system comprising a skeleton including one or more subsystems such as compression or crush zones and a hoist subsystem for the safe and efficient transportation of battery modules. These systems and subsystems are strategically located for optimal performance, commonly connected to the main vehicle structure.

The present disclosure herein is an over the road vehicle that can include a trailer mounted battery pack system comprising of a steel rack structure, a plurality of battery modules connected in series and parallel configurations, power electronic systems, charging systems, high voltage input output interfaces and a variety of high/low voltage connections. These systems and subsystems are strategically located for optimal performance, commonly connected to the main vehicle structure.

In general, all-electric, portable, industrial power generators include one or more battery cells to provide stored energy that may be converted into electrical AC or DC power. The industrial power generator may use several battery cells to supply sufficient electrical capacity and/or voltage for any DC/DC converters, power inverters, or any other associated circuitry. The battery cells themselves can be removably mounted or affixed into a receiving frame within the industrial power generators.

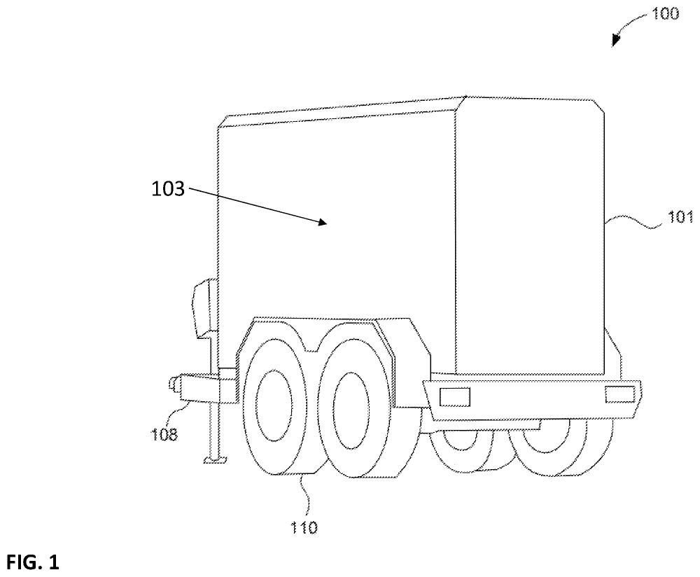

FIG. 1 is a view of an example mobile power unit 100. The mobile power unit 100 may be an all-electric or hybrid power unit configured to provide alternating current (AC) and/or direct current (DC) power on demand for any feasible use. In some embodiments, the desired electrical output is chosen by the user from a pre-selected group of common electrical outputs (e.g., 480VAC 3-Phase, 208VAC 3-Phase, 240VAC 1-Phase, 120VAC 1-Phase or the like). In another embodiment, the user can select any desired output voltage amplitude, frequency, and phase shift, allowing the mobile power unit to provide any user-selected electrical output. The mobile power unit 100 can further be configured to provide a regulated DC output (e.g., for electric vehicle charging). In some embodiments, the mobile power unit 100 may be controlled through an integrated control panel or through a GUI implemented on a remote device, such as a smartphone, tablet, or PC, which can be configured to communicate with the mobile power unit via wireless technologies such as Bluetooth, Wi-Fi, cellular, etc.

The mobile power unit 100 can include an electrical energy source 103 (e.g., one or more batteries) disposed within a housing 101. In one configuration, the electrical energy source comprises a plurality of lithium-ion battery cell groups arranged in series and/or parallel connections. In other embodiments, the electrical energy source can comprise other known energy storage devices, such as ultracapacitors or fuel cells. While lithium-ion is presently the preferred battery cell type, it should be understood that other battery cells can be used in place of lithium-ion cells as battery technology evolves. In some examples, the electrical energy source can have an operating voltage range of 300-450 volts. In other embodiments, the electrical energy source can have a higher operating voltage range of 450-1000 volts.

The mobile power unit 100 can include a trailer 108 configured to attach to a trailer hitch or tow vehicle, and a plurality of wheels 110 which allow for easy transportation and delivery of the mobile power unit to remote sites. The size of the mobile power unit 100 can vary depending on electrical output and energy storage capabilities, but in general, the mobile power unit 100 itself can range in size from approximately 50″ long, 30″ wide, and 50″ tall up to 150″ long, 60″ wide, and 60″ tall. The trailer can add an extra 50-70″ in length and 20-30″ in height depending on the size and weight of the mobile power unit 100 and the number and size of wheels required to carry the weight of the mobile power unit 100. In a preferred embodiment, the mobile power unit 100 is approximately 100″ long, 40″ wide, and 60″ tall, with the trailer adding an additional 40-50″ in length and 15-30″ in height. In other embodiments, the mobile power unit can be scaled up or down in terms of operating voltage range and outputs, and the size of the mobile power unit 100 can be adjusted accordingly.

The mobile power unit described herein may be configured to house, support, transport, etc. rechargeable electric power systems comprising one or more components and connections that would benefit from the structural support of the hoist system and compression zones described herein. For example, the mobile power unit can include an electrical energy source which can comprise, for example, a plurality of battery cells. The electrical energy source can be electrically connected to a power distribution unit (PDU), which includes a plurality of electrical inputs and outputs configured to distribute electrical power throughout the mobile power unit. The mobile power unit can include additional electrical components, such as a battery management system (BMS), one or more system controllers or processors, electrical connections, inverter stages, power convertors, etc., the details of which are described in related pending applications but is beyond the scope of this disclosure.

In some examples, any, all or none of the electrical components and connections may be coupled to or in communication with the mobile power unit trailer systems described herein.

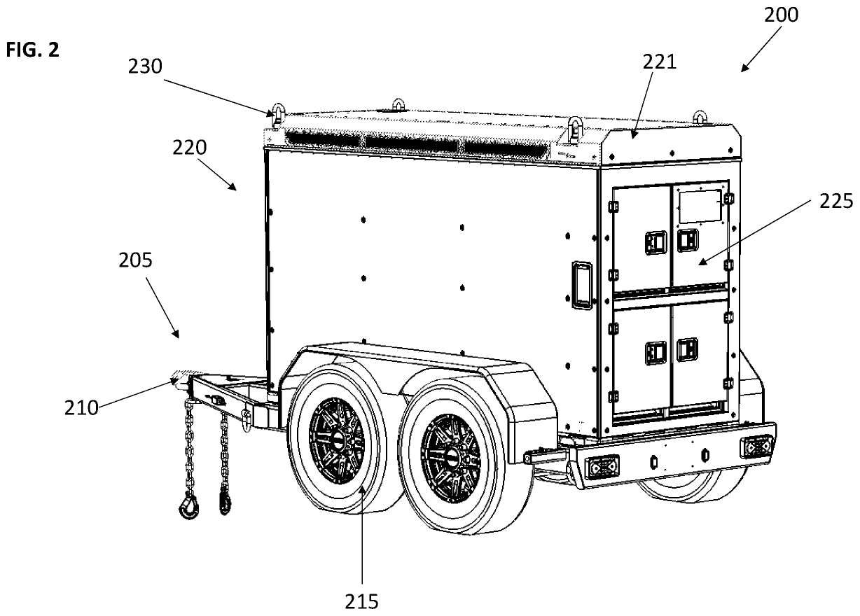

Additional details of a mobile power unit 200 are shown in FIG. 2. A trailer frame 205 has a coupler 210 and wheels 215 to facilitate maneuverability of the mobile power unit 200. A housing 220 is positionable on the towable frame 205 and can be configured to house an energy source (e.g., electric power source) therein. The housing 220 can have a top portion 221 separated from the towable frame 205 by sidewalls. Access panels 225 can be configured to provide access to an interior of the housing 200 and may be locatable on any surface of the housing 200. For example, FIG. 2 illustrates an example of access panels 225 at the rear of the housing 220. The access panels may provide access to the energy source within the housing, or alternatively, may provide access to controls/electrical outputs of the housing but not the energy source.

The mobile power unit may include one or more compression or crumple zones strategically located to have a different structural integrity than other elements, areas, regions, etc. of the housing 220. For example a compression zone may be designed and configured to transfer kinetic energy at impact into a controlled deformation, crumpling, or crushing, to crush, collapse, crumple, dent, bend, etc. at a different rate than other more rigid aspects of the mobile power unit (e.g., a sidewall). In some examples, the compression zones can be configured to absorb contact with an object, surface, substrate, etc. Absorbing an impact via a compression zone of the housing can prevent or reduce damage to the housing and maintain the structural integrity and function of the power source therein. In some aspects, the compression or crumple zones are configured to prevent damage to the energy source within the housing. For example, the energy source (e.g., batteries) can be positioned within the housing interior to the crumple zones. When one or more crumple zones collapse or deform in response to a collision, the deformation is contained or confined to the crumple zone and does not extend into the energy source or batteries.

Lifting hoist locations 230 are shown in position at or near a top portion 221 of the housing 220. In this example, the lifting hoist locations 230 are lifting rings and can be configured to provide an attachment location for securing the trailer system to a lift (not shown) for lifting or changing a vertical position of the trailer system 200. For example, a cable from a crane can be attached to the lifting rings 230 and the trailer system 200 can be lifted.

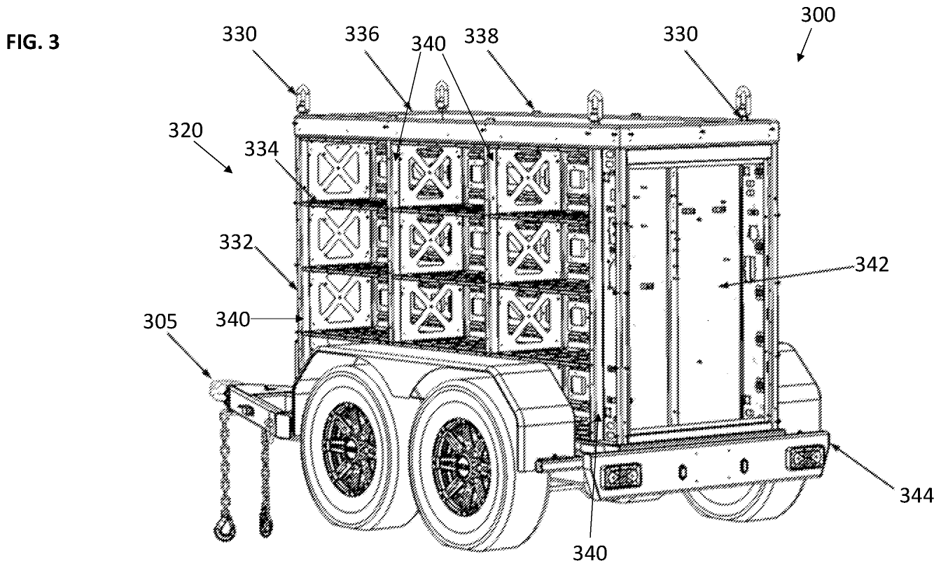

FIG. 3 illustrates an example of a mobile power unit 300 with sidewalls removed to expose internal detail of the housing 320. In this view, the mobile power unit includes a trailer frame 305, a rechargeable energy storage system rack structure 332, battery module shelves 334, lifting hoist locations 330, top tubular surround structure 336, threaded rod cap(s) 338, vertical pillar subsystems 340, vertical pillar cross member(s) 342, and rear bumper 344. The individual battery units or battery modules can be housed in the rack structure 332, each battery unit or module being supported by a battery module shelf 334.

Here, the top tubular surround structure 336 is configured to provide a frame for housing many electrical components of the mobile power unit, such as the inverters, BMS, PDU, etc. described above.

As shown in FIG. 3, the mobile power unit can include a plurality of vertical pillar subsystems 340 positioned throughout the housing 320, the vertical pillar subsystems being pre-stressed during production fabrication to circumvent vertical motion and high forces applied to the lifting hoist locations during transportation or lifting (e.g., with a crane or helicopter). In some examples, the vertical pillar subsystems 340 may extend through the housing from one side to an opposite side of the housing (e.g., from a top of the housing through to a bottom of the housing). In some examples, vertical pillar subsystems 340 may extend from the one side or area of the housing to another (e.g., opposite) side of the housing. When the housing is lifted via a lifting hoist location 330, the entire trailer system is lifted as the upward force is distributed from the lifting hoist location 330 through the associated vertical pillar subsystems 340 to the towable trailer. In another embodiment, the housing may be removably coupled with the towable frame allowing for lifting and maneuverability of the housing independent of the towable frame.

In some examples, each vertical pillar subsystem 340 may extend from a lifting hoist location 330 to a bottom surface of the housing. As shown in FIG. 3, the housing can also include vertical pillar subsystems 340 at locations that do not include lifting hoist locations, but instead terminate at threaded rod caps 338. In the illustrated embodiment, the housing includes lifting hoist locations at each of the four corners of the housing. However, vertical pillar subsystems are also positioned centrally within the housing at the threaded rod cap locations. These vertical pillar subsystems can be placed strategically throughout the rack structure 332, such as between groupings of battery modules. In the embodiment of FIG. 3, the housing includes a total of eight vertical pillar subsystems, four positioned at the corners and associated with a lifting hoist location, and four internal to the housing and terminating at the threaded rod cap locations.

Referring to FIG. 3, one or more cross members 342 may be positioned within the housing 320. A cross member may be configured to provide additional structural support, added mounting locations and surfaces, define an interior surface of a compression zone, etc. or a combination thereof. As illustrated in FIG. 3, the cross member 342 is extending between two or more vertical pillar subsystems.

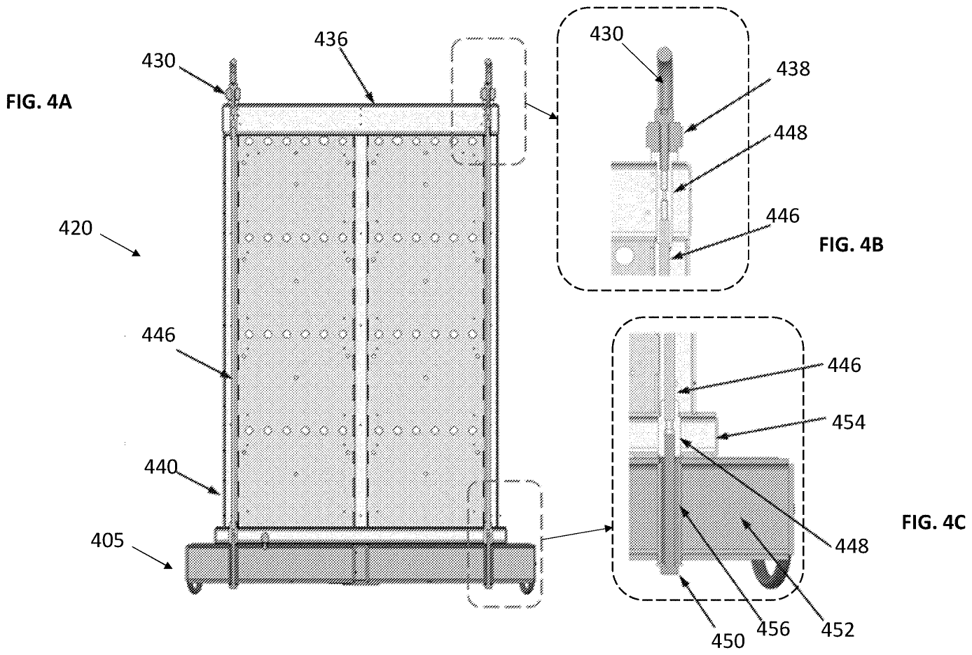

FIG. 4A to 4C illustrate an example of a mobile power unit, as described herein, with additional detail reading the vertical pillar subsystems. A rear-view of the housing 420 shows lifting hoist locations 430, top tubular surround structure 436, and vertical pillar subsystems 440 extending between the trailer 405 and two or more lifting hoist locations 430. As shown in FIG. 4A, each vertical pillar subsystem can include a high strength steel threaded rod 446 disposed within each vertical pillar and extending top-to-bottom through the housing and/or trailer of the mobile power unit.

FIG. 4B is an exploded view of the upper portion of the vertical pillar subsystem, showing the lifting hoist location 430 inserted into a threaded rod cap 438. A coupling element 448 can be configured to attach the lifting hoist location 430 to the threaded rod 446. In any example, the coupling element may be a threaded coupler, compression coupler, welded coupler, or any other coupler configured to connect, attach, or couple the lifting hoist location to the elongate member. The coupling element further allows for pre-tensioning the threaded rod within the vertical pillar to circumvent vertical motion and high forces applied to the threaded rods during pickup/movement via the lifting hoist locations.

Referring to the expanded view in FIG. 4C, the lower portion of the vertical pillar subsystem is shown, showing the coupling/attachment of the housing 420 to the towable trailer 405. As with the example in FIG. 4B, the lower portion of the vertical pillar subsystem includes a connection between the threaded rod 446 and a coupling element 448. A bolt 450 passes through an underside of the trailer 405, including a trailer cross member 452, and is configured to attach to the coupling element 448 to lock and tension the threaded rod 446 in position. The bolt 450 may have an elongate body configured pass through the towable trailer and optionally a lower tubular surround structure 454 with a bolt head configured to prevent the bolt from being drawn entirely through the towable trailer. A compression sleeve 456 may be positioned around the body of the bolt to retain the bolt in place and reduce inadvertent displacement of the bolt during use or installation.

FIG. 4C also shows a lower segment of the lower tubular surround structure 454 positioned on top of the towable frame 405 where the threaded rod and bolt are coupled. The length of the bolt and threaded rod may be any length such that the point of coupling between the threaded rod and the bolt may be at any position between and including the towable frame 405 or the lower tubular surround structure 454 (as illustrated.

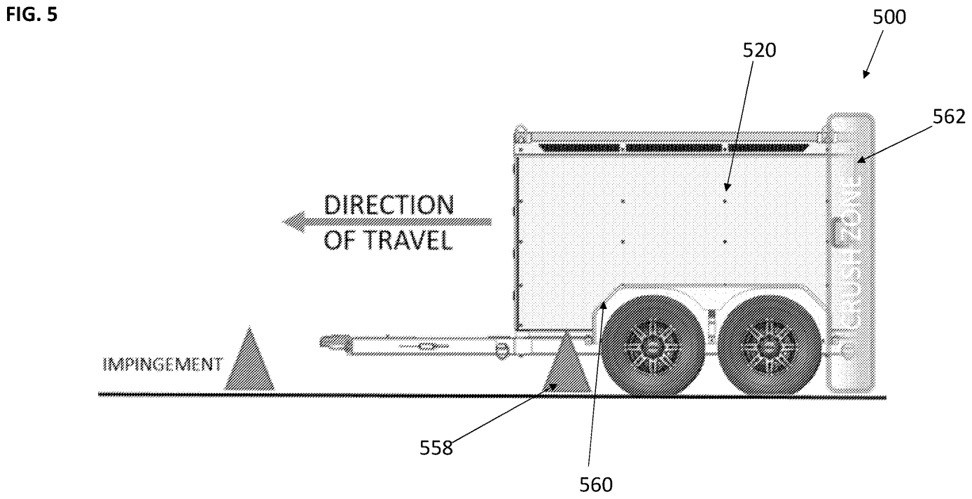

FIG. 5 to FIG. 7 illustrate examples and additional detail of the compression or crumple zones in the mobile power unit, including in the housing and/or in the towable trailer. The compression zones may be configured to be sacrificial components, areas, regions, etc. of the system configured to absorb an impact or collision and absorb and distribute the force of the impact throughout the compression zone and remaining system structure while preventing negative impact to the energy storage components stored therein. These sacrificial zones can prevent the transmission of forces due to impact from damaging the electrical storage system (e.g., batteries electrical connections, etc.). In some examples, the components of a compression zone, subframe, hoist subsystem, etc. may be configured to be replaceable to improve the capacity for the mobile power unity trailer system to be repaired after an impact.

In FIG. 5, an example of a mobile power unit 500 is illustrated in motion towards impingements 558 that may result in an impact to the housing or trailer. In this example, the impingements may impact the fender 560 of the mobile power unit. Accordingly, the fender 560 may provide a compression zone configured to contact the impingement 558 and sufficiently collapse, compress, etc. to absorb, dissipate, distribute, etc. the forces associated with the impact to prevent those forces from negatively impacting the energy storage system contained within the housing 520. The mobile power unit can further include a compression or crush zone 562 at a rear of the housing that can provide additional support in such a scenario that may also include impact or contact from another trailing vehicle (not shown). In some embodiments, the crush zone 562 can be the location of user controls, user interfaces or GUI's, any displays of the mobile power unit, and/or the electrical output connections to the user. These components can be placed in the crush zone 562 to provide a sacrificial section in the back of the mobile power unit that is configured to collapse, compress, or crush during a collision potentially sparing the actual battery modules from impact damage.

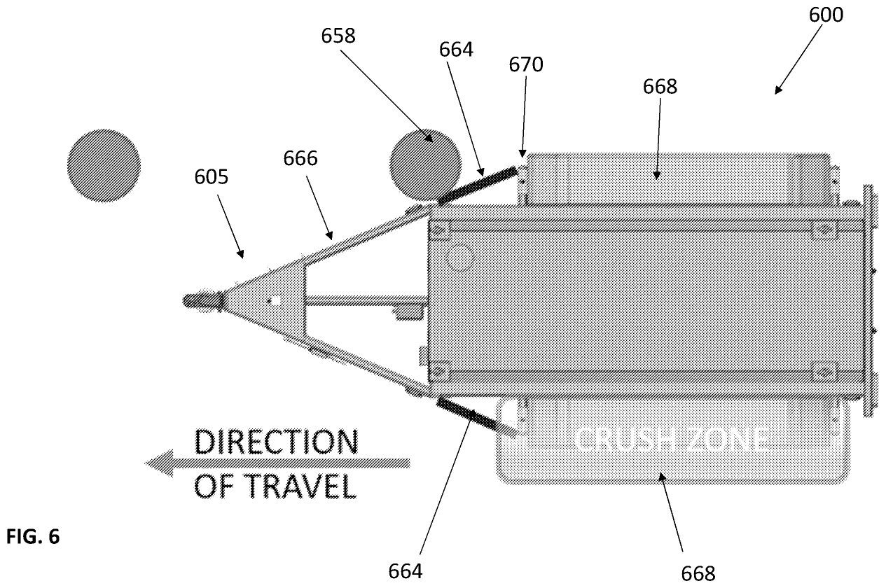

In FIG. 6, a mobile power unit 600 is shown from the top where an object (e.g., impingement) 658 is adjacent to the trailer frame 605. In this example, the trailer frame comprises a pair of winglets 664 that are angled to deflect or minimize damage in the event of a frontal strike with the impingement 658. It can be seen in FIG. 6 that the trailer frame 605 includes a front frame portion 666 that is generally triangular in shape between the trailer hitch component and where the mobile power unit housing resides. Without the winglets 664, any frontal impact with the impingement 658 would result in a direct hit with the fenders/wheels of the trailer, as shown by crush zones 668. However, with the winglets 664, the potential impact with the impingement 658 may result in the winglets deflecting the impingement, instead of the fenders/wheels taking a direct impact. This can help to avert major damage to the trailer and/or mobile power unit in the event of a frontal collision. In some embodiments, the winglets a directed in generally the same angle/direction as the angle/direction of the front frame portion 666. In other embodiments, the winglets can be angled differently than the front frame portion, but can still be designed and configured to prevent a front portion 670 of the fenders from striking road objects or impingements.

Also in FIG. 6, a compression zone (e.g., crush zone) 668 is shown in the region of the fenders/wheels of the trailer, as viewed from the top. Accordingly, the winglets 664 may contact the impingement 658 which may deflect some or all of the collision forces, followed by impact between the object 658 and the crush zone 668 to further accommodate the forces from the impact without transferring those forces to the components contained within the housing.

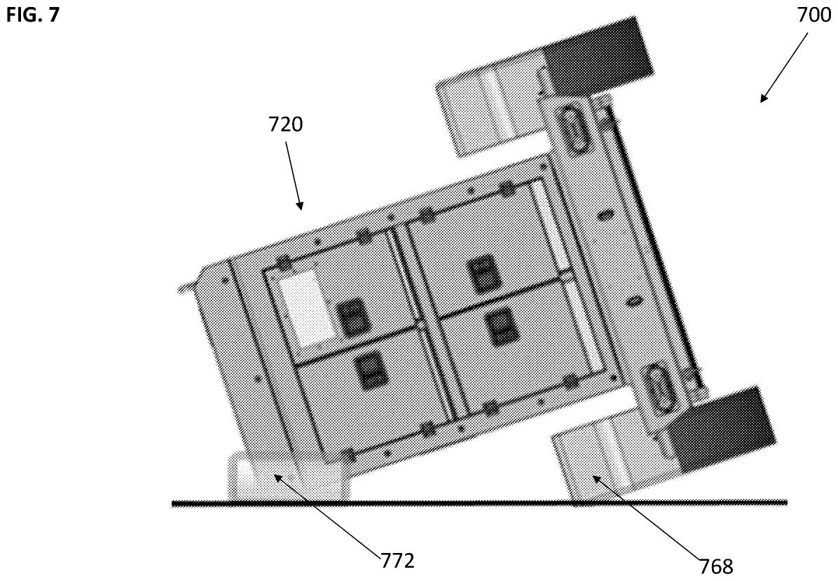

FIG. 7 illustrates yet another example scenario where a trailer system 700 described herein may experience an impact and a compression zone 772 can accommodate the forces of the impact without allowing them to transfer to the components contained within the housing 720. As illustrated in FIG. 7, a compression zone 772 along the upper perimeter of the housing 720 is in contact with a surface (e.g., a road). For example, the trailer system 700 has tipped over or rolled over causing the compression zone 772 to contact the road. Accordingly, the compression zone may accommodate the impact between the housing 720 and the road such that the compression zone can compress, collapse, or otherwise accommodate forces from the impact with the road to prevent or reduce transmission of those forces through the housing 720. to the energy storage system contained within the housing 720.

Considering the examples illustrated in FIG. 6 and FIG. 7, compression zones may be positioned at one or more areas throughout the trailer frame, housing, fenders, wheels, etc. and can be configured to function in combination with one or more other compression zones to improve accommodation of the forces from an impact. For example, in FIG. 7, as a trailer may have rolled over and the compression zone contacts the road, the fender or crush zone 768 may provide for an additional compression zone that can support the accommodation of the forces from the impact such that the forces may be shared between the compression zone 772 and the fender compression zone 768.

In any examples described herein, battery pack transportation system (e.g., mobile power unit trailer system) level may include compression zones or subsystems configured for road debris impingement mitigation, forward motion strike deflection, side impact protection (crumple zone) both vehicular and side post, rear crumble zone and roll over crush zone. In any examples described herein, the system may comprise features (e.g., attachment elements) for lifting the unit via, for example, a crane or a helicopter. Some examples of materials comprising any of the components described herein may be high strength steel, high strength low carbon steel, or any type of alloy polymer or material with the capacity to function as described herein. In some examples, regarding the hoist subsystem, the elongate members may be buried within the vertical pillars of structure, and may be pre-stressed during the production fabrication to alleviate vertical motion and forces applied to the lifting rods during a crane or helicopter hoist of the system.

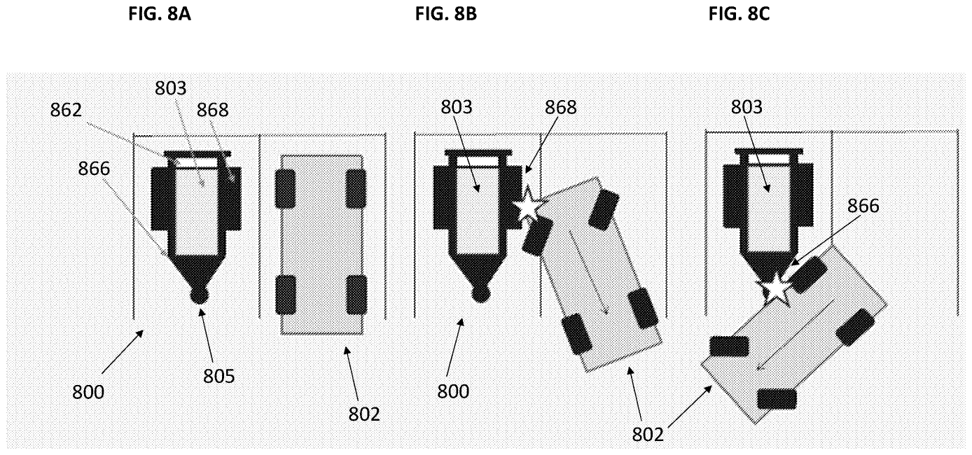

FIGS. 8A-8C illustrate scenarios where a mobile power unit 800 is positioned in a parking spot adjacent to another vehicle 802. As described above, the mobile power unit can include an energy source 803 disposed within the mobile power unit housing, one or more crush or compression zones 868, 866, and 862 integrated within or surrounding the housing, and a towable trailer frame 805. FIG. 8B shows an example of the vehicle 802 pulling out of the location adjacent to the mobile power unit causing a fender strike with crush or compression zone 868. The resulting collision causes compression of the crush zone 868, preventing damage to the energy source 803 within the mobile power unit. Similarly, FIG. 8C shows the vehicle 802 pulling out and turning across the front of the mobile power unit, causing a collision with crush zone 866 of the towable trailer frame 805. Similar to FIG. 8B, this collision results in compression of the crush zone 866, preventing damage to the energy source 803.

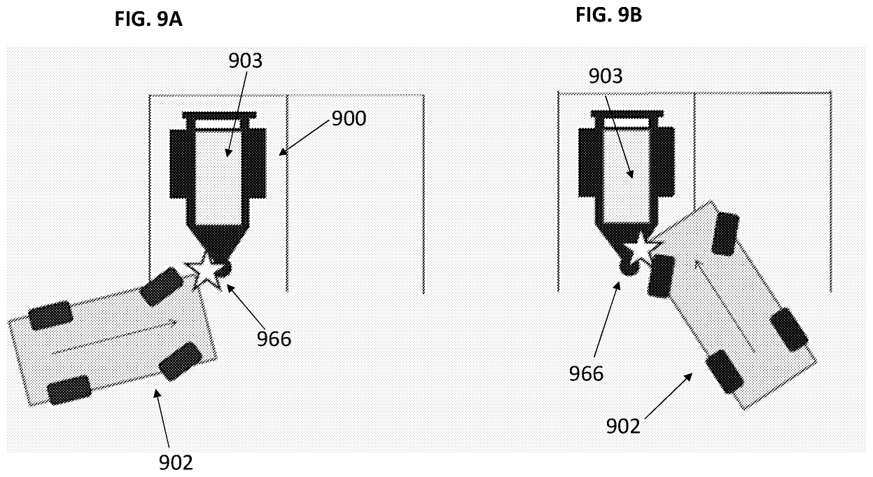

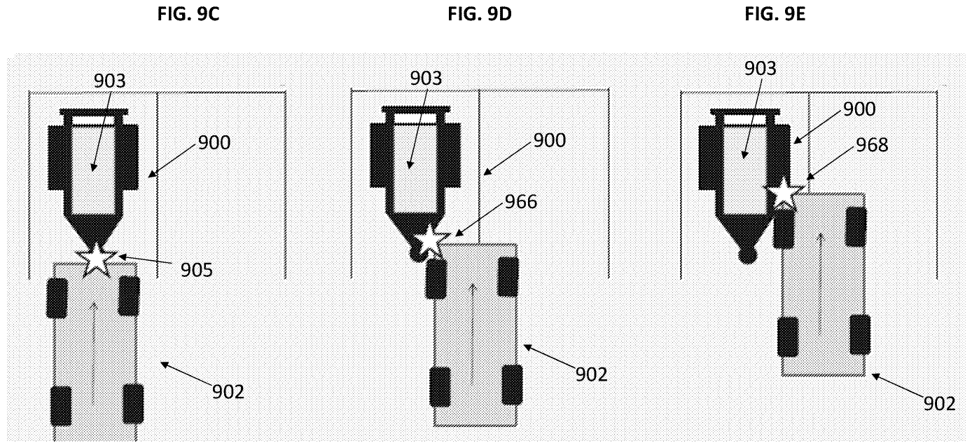

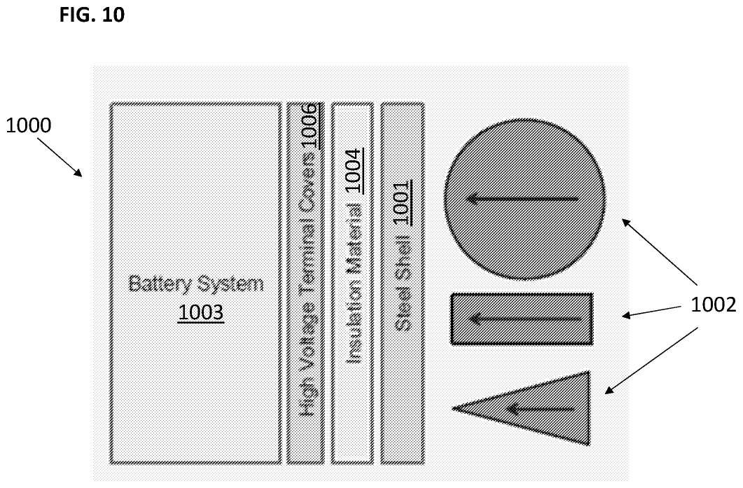

FIGS. 9A-9B show similar protections afforded by the towable trailer frame and crush zones of the mobile power unit 900, for situations in which a vehicle 902 is pulling into a location adjacent the mobile power unit. In both these scenarios, an approaching vehicle 902 turning into a parking spot adjacent to the mobile power unit results in a collision with crush zone 966 of the towable trailer frame, resulting in no damage to the energy source 903 within the mobile power unit.

Similarly, head-on collisions with the front of a mobile power unit 900 are shown in FIGS. 9C, 9D, and 9E, with the resulting collisions resulting in damage/compression of the towable trailer frame 905, crush zone 966, and crush zone 968, respectively, preventing damage to the energy source 903 in each instance.

FIG. 10 is a schematic diagram showing various safety systems and components that are in place to protect a mobile power unit 1000 from collisions with unknown objects 1002. As described above, the mobile power unit can include an energy source or battery system 1003 disposed within a housing 1001 that can comprise a steel shell with one or more crush or crumple zones therein. Between the battery system and the housing 1001 can be located high voltage terminal covers 1006 and an insulation material 1004. In the event of a collision with the mobile power unit, the crush or crumple zones can deform to absorb the impact and prevent damage to the internal components of the housing. Additionally, insulation material or layers 1004 can be provided to prevent the battery system from short circuiting with the steel shell of the housing 1001. Despite the crush zones and insulation material, in the event that there is a short circuit event, the battery system and high voltage terminal covers can have included redundant fusible links to disconnect themselves from the rest of the mobile power unit thereby breaking any short circuit event and failing safely.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A towable system for transporting a mobile power unit, the system comprising:
a frame having a coupling mechanism configured to attach to a vehicle; and
a housing operably coupled with the frame and configured to house one or more battery modules, the housing comprising one or more compression zones configured to accommodate an impact to prevent damage to the one or more battery modules.

2. The towable system of claim 1, further comprising one or more attachment rings coupled to an elongate member extending through the housing to the frame.

3. The towable system of claim 1, further comprising a first compression zone along a length of an upper perimeter of the housing.

4. The towable system of claim 1, wherein the frame comprises a compression member extending between a fender and a proximal side of the frame.

5. The towable system of claim 1, comprising at least four attachment rings positioned on an upper surface of the housing, each attachment ring coupled to an elongate member extending through the housing to the frame.

6. The towable system of claim 5, wherein each attachment ring is configured to engage with a cable to lift the towable system.

7. The towable system of claim 1, wherein the housing comprises cross members extending between elongate members of a hoist system within the housing.

8. The towable system of claim 1, wherein the housing comprises a subframe configured to distribute force from an impact away from the one or more battery modules.

9. The towable system of claim 1, comprising a top positioning on the top of the housing, wherein the top is a compression zone.

10. The towable system of claim 1, wherein the housing comprises a rear surface compression zone.

11. The towable system of claim 1, wherein the one or more compression zones is defined by a channel extending along a length of the housing perimeter, and one or more compression supports extending across the channel.

12. A trailer for a battery mounting system comprising:
a housing comprising one or more compression zones, wherein the housing is attached to a frame configured to be towed by a vehicle, the housing further configured receive one or more battery housings in a receiving frame, the receiving frame comprising:
a locating rail attached to the receiving frame and configured to form at least one side of the receiving frame; and
a first mounting bracket removably attached to the receiving frame; and
a battery housing comprising:
a sleeve configured to securely attach to a battery cell and at least partially cover at least three sides of the battery cell;
a first locator pocket disposed on a first side of the sleeve, wherein the first locator pocket is configured to receive a first portion of the locating rail; and
a second locator pocket disposed on an upper edge of a second side of the sleeve, the second side disposed opposite to and across from the first side, wherein the second locator pocket is configured to receive a first spring force from the first mounting bracket to affix and secure the battery housing against the locating rail.

13. The towable system of claim 12, further comprising one or more attachment rings coupled to an elongate member extending through the housing to the frame.

14. The towable system of claim 12, further comprising a first compression zone along length of an upper perimeter of the housing.

15. The towable system of claim 12, comprising at least four attachment rings positioned on an upper surface of the housing, each attachment ring coupled to an elongate member extending through the housing to the frame.

16. The towable system of claim 15, wherein each attachment ring is configured to engage with a cable to lift the towable system.

17. A portable power system comprising:
a frame configured to be towed by a vehicle;
a housing attached to the frame, the housing configured to secure a power source therein;
one or more compression zones configured to accommodate an impact; and
one or more attachment rings, each attachment ring coupled to an elongate member extending through the housing to the frame.

18. The portable power system of claim 17, further comprising a first compression zone along a length of an upper perimeter of the housing.

19. The portable power system of claim 17, wherein the frame comprises a compression member extending between a fender and a proximal side of the frame.

20. The portable power system of claim 17, comprising at least four attachment rings positioned on an upper surface of the housing, each attachment ring coupled to an elongate member extending through the housing to the frame.

21. (canceled)

22. (canceled)

23. (canceled)

24. (canceled)

25. (canceled)

26. (canceled)
